(19) United States
(12) Patent Application Publication
(10) Pub. No.: US 2014/0152405 A1
(43) Pub. Date: Jun. 5, 2014

(54) COUPLER STRUCTURE OF MOBILE TERMINAL AND MOBILE TERMINAL INCLUDING THE SAME

(71) Applicant: Samsung Electronics Co., Ltd., Gyeonggi-do (KR)

(72) Inventors: Jae-Young HUH, Seoul (KR); Kyu-Sub KWAK, Seoul (KR); Dong-Churl KIM, Gyeonggi-do (KR); In-Kuk YUN, Gyeonggi-do (KR); Jea-Hyuck LEE, Gyeongg i-do (KR)

(73) Assignee: Samsung Electronics Co., Ltd., Gyeonggi-do (KR)

(21) Appl. No.: 14/096,687

(22) Filed: Dec. 4, 2013

(30) Foreign Application Priority Data
Dec. 5, 2012 (KR) 10-2012-0140322

(51) Int. Cl. H04B 5/00

(52) U.S. Cl. CPC H04B 5/0093
USPC 333/24 R

(57) ABSTRACT

A coupler structure of a mobile terminal having a repeater applied thereto is provided. The coupler structure includes a first substrate having a reception coupler, a second substrate having a transmission coupler, and a repeater disposed between the first substrate and the second substrate.

### PRIORITY

This application claims priority under 35 U.S.C. §119(a) to Korean Application Serial No. 10-2012-0140322, which was filed in the Korean Intellectual Property Office on Dec. 5, 2012, the entire content of which is incorporated herein by reference.

### BACKGROUND OF THE INVENTION

1. Field of the Invention

The present invention relates generally to a mobile terminal, and more particularly, to a coupler structure of a mobile terminal having a repeater applied thereto.

2. Description of the Related Art

Short-range radio communication devices can use magnetic coupling, inductive coupling, or Near Field Magnetic Induction (NFMI) to transmit and receive data, and to receive electric power. A wireless communication technology that uses magnetic coupling to transmit electric power or data will aim to transmit electric power with minimal electric power loss.

Therefore, when transmitting electric power, couplers are designed to have a large inductance, so as to introduce a large mutual inductance between the couplers. When transmitting data between mobile terminals, between structural elements in a mobile terminal, or between components in a package, only a low data rate is transmitted due to coupler design limitations. For transmission of data in the package, various components of the package will transmit data at different data transmission rates, with a higher data transmission rate between dies in the package, compared to transmission by wire. Since a distance between the dies in the package is within several hundred μm, couplers are very small.

FIG. 1 illustrates wireless data transmission using a coupler between conventional structural elements.

As shown in FIG. 1, the conventional structural elements wirelessly transmit data through a first coupler 112 of a first substrate 110 and a second coupler 122 of a second substrate 120. The first substrate 110 includes a first Integrated Circuit (IC) 111 for receiving data from the second substrate 120 and the first coupler 112 located thereon, and the second substrate 120 includes a second IC 121 for receiving data from the first substrate 110 and the second coupler 122 located on thereon. The first and second substrates typically have a gap 130 of 1 mm there between, which varies depending on design. The substrate may be a printed circuit board. The second IC 121 of the second substrate 120 wirelessly transmits data to the first IC 111 of the first substrate 110, and alternatively wirelessly receives data from the first IC 111 of the first substrate 110.

FIG. 2 provides an equivalent circuit of the first substrate and the second substrate shown in FIG. 1.

As shown in FIG. 2, the equivalent circuit of the first and second substrates shown in FIG. 1 is constituted of an NFMI Transmitter (NFMITx) 210 for wirelessly transmitting data, an NFMI Receiver (NFMIRx) 220 for wirelessly receiving data, an inductance 211 of the NFMITx 210, and an inductance 212 of the NFMIRx 220 disposed at a distance of 1 mm from the inductance 211. The transmission and the reception of data between the inductance 211 of the NFMITx 210 and the inductance 212 of the NFMIRx 220 may be achieved by a magnetic coupling 213.

When the size of the coupler and distance between the couplers are limited, considering a property of the coupling, Self-Resonance Frequency (SRF) is increased by reducing a parasitic capacitance, with an increase of mutual inductance between the substrates. That is, the SRF decreases when reactance increases, in order to increase the mutual inductance, and on the contrary, mutual inductance decreases when reactance is reduced, in order to increase the SRF. Since the parasitic capacitance is a factor having a small value, a design satisfying two properties is impossible.

Further, when the SRF is largely maintained, a constant value of the coupling is increased to increase the mutual inductance, and the design must include a coupler having a maximum size, with a shortest possible distance between the couplers. However, in order for a structural element in a mobile terminal to transmit data, couplers must have a limited size, i.e. within several mm, and a distance between the couplers must exceed 1 mm.

### SUMMARY OF THE INVENTION

The present invention has been made to address at least the problems and/or disadvantages described above and to provide at least the advantages described below.

Accordingly, an aspect of the present invention provides an interface for transmitting short-range radio data between structural elements in a mobile terminal by applying a repeater to a coupler structure in the mobile terminal.

Another aspect of the present invention provides a coupler structure for maintaining a high self-resonance frequency while having a high mutual inductance between couplers regardless of a distance between couplers.

In accordance with an aspect of the present invention, a coupler structure is provided, which includes a first substrate having a reception coupler, a second substrate having a transmission coupler, and a repeater disposed between the first substrate and the second substrate.

In accordance with another aspect of the present invention, a coupler structure of a mobile terminal is provided, which includes a first substrate; a second substrate; and a repeater disposed between the first substrate and the second substrate and having a coupler arranged thereon, with the repeater having adhesive films attached to upper and lower surfaces thereof, and including at least one magnetic shield material and at least one flexible substrate.

According to another aspect of the present invention, a coupler structure of a mobile terminal to which a repeater is applied is provided, to wirelessly transmit data at a high speed regardless of a distance between the couplers with a size of the coupler being fixed, i.e., fixing a magnitude of an inductance and a vortex capacitance of the coupler.

According to another aspect of the present invention, a repeater is applied to a coupler structure in a mobile terminal to wirelessly transmit data and/or electric power, thereby making it possible to transmit data at a higher rate than that in a manner of wirelessly transmitting data through only a coupler.

### BRIEF DESCRIPTION OF THE DRAWINGS

The above and other aspects, features, and advantages of the present invention will be more apparent from the following detailed description taken in conjunction with the accompanying drawings, in which:

FIG. 1 illustrates wireless data transmission using a coupler between conventional structural elements;

FIG. 2 illustrates an equivalent circuit of FIG. 1;

FIG. 3 is a block diagram illustrating components of a mobile terminal according to an embodiment of the present invention;

FIG. 4 illustrates a structure of a coupler for transmitting data between structural elements in a mobile terminal at a high speed according to an embodiment of the present invention;

FIG. 5 illustrates an equivalent circuit of FIG. 4 according to an embodiment of the present invention;

FIG. 6A illustrates a repeater according to an embodiment of the present invention;

FIG. 6B illustrates an equivalent circuit of FIG. 6A;

FIG. 7A illustrates a structure of a repeater which is not constituted of a magnetic shield material;

FIG. 7B illustrates an equivalent circuit of FIG. 7A;

FIG. 8 illustrates a coupler structure in which a repeater is applied between structural elements in a mobile terminal according to an embodiment of the present invention;

FIG. 9 illustrates an equivalent circuit of FIG. 8according to an embodiment of the present invention;

FIG. 10 illustrates a structure of a coupler in which a repeater is applied between the structural elements in a mobile terminal of FIG. 9;

FIG. 11 illustrates an equivalent circuit of FIG. 10 according to an embodiment of the present invention;

FIG. 12A is a graph illustrating a result of comparison of a conventional coupler and a coupler according to an embodiment of the present invention, with a variation of a magnitude of mutual inductance, as a distance between the couplers is varied;

FIG. 12B is a graph illustrating a result of comparison of a conventional coupler and a coupler according to an embodiment of the present invention, varying frequency as a distance between the couplers is varied;

FIG. 13A illustrates a misaligned arrangement between a transmitting coupler and a receiving coupler according to a distance of the couplers;

FIG. 13B illustrates a result of a misaligned arrangement between the transmitting coupler and the receiving coupler; and

FIGS. 14A to 14C illustrate results of transmitting a high rate digital data through a coupler.

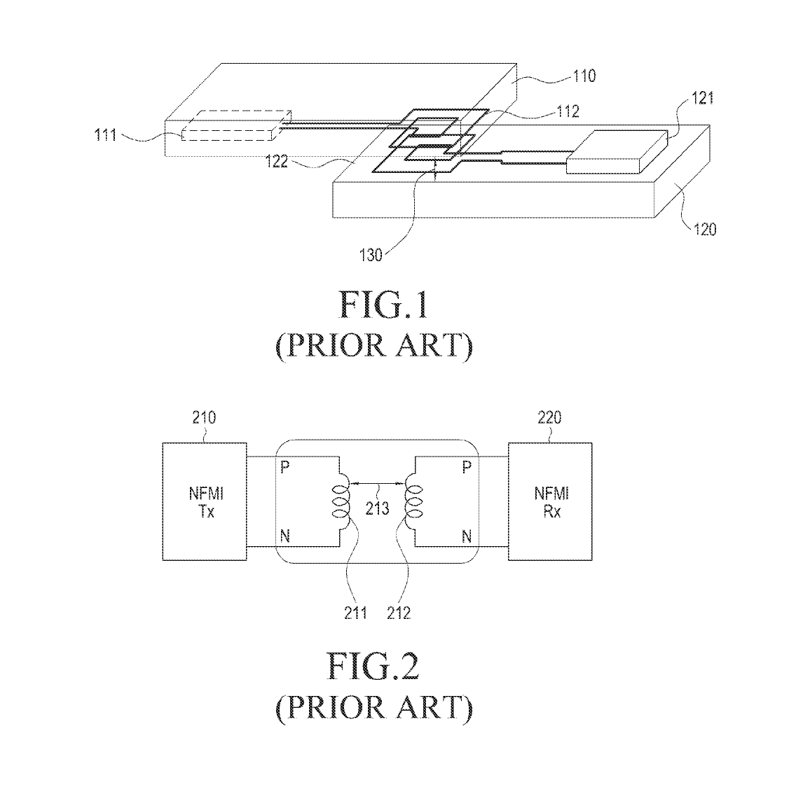

### DETAILED DESCRIPTION OF EMBODIMENTS OF THE PRESENT INVENTION

Various embodiments will now be described more fully with reference to the accompanying drawings in which embodiments of the present invention are shown. Therefore, it should be understood that there is no intent to limit the embodiments to the particular forms disclosed, but on the contrary, the embodiments are provided to cover all modifications, equivalents, and alternatives falling within the scope of the invention.

While terms including ordinal numbers, such as “first” and “second,” etc., may be used to describe various components, such components are not limited by the above terms. The terms are used merely for the purpose to distinguish an element from the other elements. For example, a first element could be termed a second element, and similarly, a second element could be also termed a first element without departing from the scope of the present invention. As used herein, the term “and/or” includes any and all combinations of one or more of the associated listed items. The terms used in this application are for the purpose of describing particular embodiments only and are not intended to be limiting of the invention.

As used herein, the singular forms are intended to include the plural forms as well, unless the context clearly indicates otherwise. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

Hereinafter, an operation principle of embodiments of the present invention will be described in detail with reference to the accompanying drawings. In the following description of the present invention, a detailed description of known functions and configurations incorporated herein will be omitted for clarity and conciseness. The terms which will be described below are terms defined in consideration of the functions in the present invention, and may be different according to users, intentions of the users, or customs. Therefore, definitions will be made based on the overall contents of this specification.

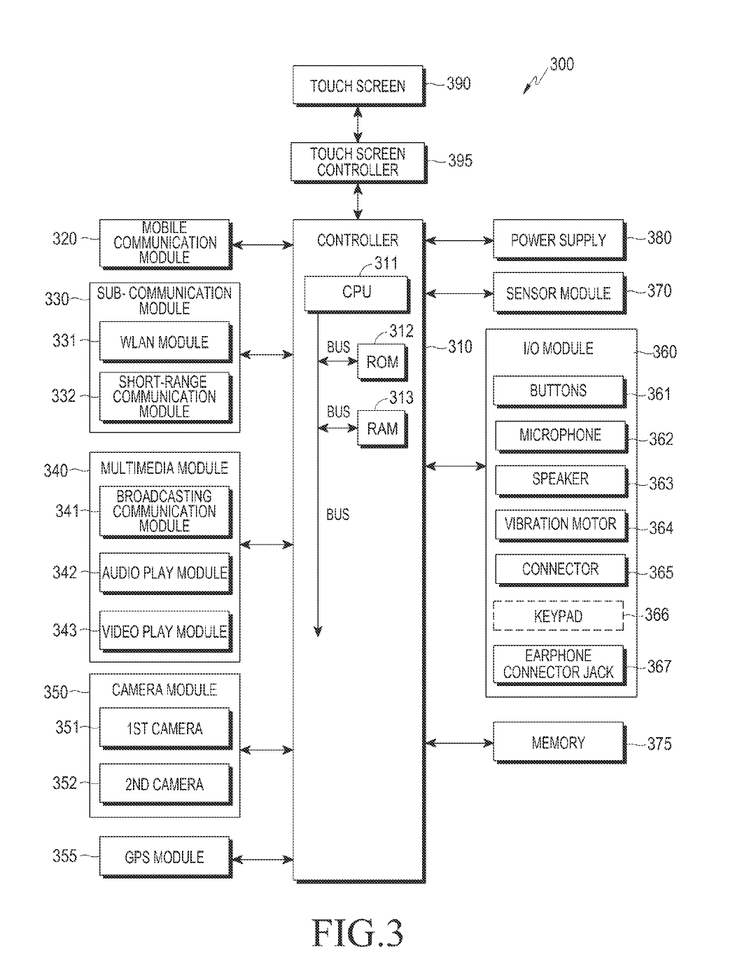

FIG. 3 is a block diagram illustrating components a mobile terminal 300 according to an embodiment of the present invention.

As shown in FIG. 3, the mobile terminal 300 may be connected to an external device by using a sub-communication module 330, a connector 365 and an earphone connection jack 367. The external device may include various devices such as an earphone which is detachably connected to the mobile terminal 300 by a wire, an external speaker, a Universal Serial Bus (USB) memory, a charger, a cradle/dock, a mobile payment unit, a health-care device such as a blood-sugar meter and the like, a game player, a navigation unit for a vehicle, and the like. Further, the external device may include one of a short-range communication unit such as a Bluetooth communication unit, a Near Field Communication (NFC) unit and a Wi-Fi direct communication device, and a wireless Access Point (AP), which are wirelessly connected to the mobile terminal 300 via short-range communication. Furthermore, the external device may include one of other mobile terminals, a portable phone, a smart phone, a tablet PC, a desktop PC and a server.

The mobile terminal 300 may be a smart phone, a portable phone, a game player, a TV, a display unit, a head-up display unit for a vehicle, a notebook computer, a laptop computer, a tablet PC, a Personal Media Player (PMP), a Personal Digital Assistants (PDA), and the like. Further, the mobile terminal 300 may be implemented as a pocket size portable and mobile communication terminal with a wireless communication function.

Referring to FIG. 3, the mobile terminal 300 includes a touch screen 390 and a touch screen controller 395. Further, the mobile terminal 300 includes a controller 310, a mobile communication module 320, a sub-communication module 330, a multimedia module 340, a camera module 350, a GPS module 355, an input/output module 360, a sensor module 370, a storage unit 375 and an electric power supply unit 380. The sub-communication module 330 includes at least one of a wireless LAN module 331 and a short-range communication module 332. The multimedia module 340 includes at least one of a broadcasting communication module 341, an audio reproduction module 342 and a video reproduction module 343. The camera module 350 includes at least one of a first camera 351 and a second camera 352. The input/output module 360 includes at least one of a button 361, a microphone 362, a speaker 363, a vibration motor 364, a connector 365, a keypad 366, and an earphone connecting jack 367.

The controller 310 may include a Central Processing Unit (CPU) 311, a ROM 312 in which a control program for a control of the mobile terminal 300 is stored, and a RAM 313 which stores signals or data input from an exterior of the mobile terminal 300, or is used as a storage region for operations performed by the mobile terminal 300. The CPU 311 may include a single core CPU, a dual core CPU, a triple core CPU, or a quad core CPU. The CPU 311, the ROM 312 and the RAM 313 are connected to one another through an internal bus.

The controller 310 is capable of controlling the mobile communication module 320, the sub-communication module 330, the multimedia module 340, the camera module 350, the GPS module 355, the input/output module 360, the sensor module 370, the storage unit 375, the electric power supply unit 380, the touch screen 390 and the touch screen controller 395.

The mobile communication module 320, the sub-communication module 330 and the broadcasting communication module 341 of the multimedia module 340 are referred to as a communication unit. The communication unit is prepared for a direct connection with the external device or a connection with the external device through a network, and may be a wired or wireless communication unit. The communication unit transmits data from the controller 310, the storage unit 375, the camera module 350, either wired or wirelessly, or receives data from an external communication line or the air either wired or wirelessly, to transmit the data to the controller 310 or store the data in the storage unit 375.

The mobile communication module 320 enables the mobile terminal 300 to be connected to the external device through a mobile communication using at least one antenna, under a control of the controller 310. The mobile communication module 320 transmits and receives radio signals for a directional transmission or reception and a data exchange of a voice call, a video call, a Short Message Service (SMS), or a Multimedia Message Service (MMS) to/from a portable phone, a smart phone, a tablet PC, or other devices which have telephone numbers or a network address input into the mobile terminal 300.

The sub-communication module 330 may include at least one of the wireless LAN module 331 and the short-range communication module 332. For example, the sub-communication module 330 may include only the wireless LAN module 331, only the short-range communication module 332, or both the wireless LAN module 331 and the short-range communication module 332.

The wireless LAN module 331 may be connected to the Internet at a location in which the wireless AP is installed, under a control of the controller 310. The wireless LAN module 331 supports the wireless LAN provision, e.g., an Institute of Electrical and Electronics Engineers (IEEE) 802.11x protocol communication. The short-range communication module 332 wirelessly performs short-range communication between the mobile terminal 300 and the image display unit (not shown), under control of the controller 310. The short-range communication scheme may include a Bluetooth communication scheme, an Infrared Data Association (IrDA) scheme, a Wi-Fi Direct communication scheme, a Near Field Communication (NFC) scheme, and the like.

The mobile terminal 300 includes at least one of the mobile communication module 320, the wireless LAN module 331 and the short-range communication module 332. Further, the mobile terminal 300 may include a combination of the mobile communication module 320, the wireless LAN module 331 and the short-range communication module 332.

The multimedia module 340 may include the broadcasting and communication module 341, the audio reproduction module 342, or the video reproduction module 343. The broadcasting and communication module 341, under a control of the controller 310, receives broadcasting signals, i.e. TV broadcasting signals, radio broadcasting signals, and data broadcasting signals, and additional broadcasting information, i.e. Electronic Program Guide (EPG) and Electronic Service Guide (ESG), which are transmitted from broadcasting stations, through broadcasting and communication antennas (not shown). The audio reproduction module 342 may reproduce digital audio files which have a file extension such as .mp3, .wma, .ogg, .wav and the like, and are stored or received, through a speaker 363 under a control of the controller 310. The video reproduction module 343 may reproduce digital video files, e.g., files having an extension that include .mpeg, .mpg, .mp4, .avi, .mov, .mkv, and the like, and are stored or received through touch screen 390 under control of the controller 310.

The multimedia module 340 may include the audio reproduction module 342 and the video reproduction module 343, except for the broadcasting and communication module 341. Further, the audio reproduction module 342 and/or the video reproduction module 343 of the multimedia module 340 may be included in the controller 310.

The camera module 350 may include at least one of the first camera 351 and the second camera 352 to take a stationary image or a video under control of the controller 310. Further, the first camera 351 or the second camera 352 may include an auxiliary light source, i.e. a flash (not shown), to provide light necessary for photography. The first camera 351 may be disposed on a front surface of the mobile terminal 300, and the second camera 352 may be arranged on a rear surface of the mobile terminal 300. Alternatively, the first and second cameras 351 and 352 may be adjacently arranged at a distance of 1 cm to 8 cm, so as to photograph a three-dimensional stationary image or a three-dimensional video.

The first and second cameras 351 and 352 may include a lens system, an image sensor, a flash and the like. The first and second cameras 351 and 352 convert optical signals input through the lens system into electric image signals, and output the electric image signals to the controller 310.

The lens system collects incident light from an exterior, so as to form an image of a subject. The lens system includes one or more lenses, and each lens may be a convex lens, an aspheric lens, and the like. The lens system is symmetric around an optical axis extending through the lens system, and the optical axis is defined as a central axis. The image sensor detects an optical image, which is formed by external light to be incident through the lens system, as an electric image signal. The image sensor includes a plurality of pixel units which are aligned in a matrix structure of M×N, and the pixel units may include a photodiode and a plurality of transistors. The pixel units accumulate electric charges created by the incident light, and a voltage of the accumulated electric charges indicates illumination by the incident light. When an image constituting the stationary image or the video, image signals output from the image sensor include a set of voltages, i.e. pixel values, output from the pixel units, and the image signal shows one frame, i.e. stationary image. A Charge-Coupled Device (CCD) image sensor, a Complementary Metal-Oxide Semiconductor (CMOS) image sensor and the like may be used as the image sensor.

A driving unit drives the image sensor under a control of the controller 310. The driving unit operates entire pixels or pixels of an interested region among the entire pixels of the image sensor depending on a control signal received from the controller 310, and outputs image data from the pixels to the controller 310.

The controller 310 processes an image input from each of the first and second cameras 351 and 352 or an image stored in the storage unit 375 frame by frame, and outputs image frames, which are converted to be adapted to a screen property, i.e. a size, an image quality, a resolution, and the like, to the touch screen 390. Further, the controller 310 may detect movement of the mobile terminal itself as a user moves, and also detect a corresponding movement using velocity, location and similar movement detectors.

The GPS module 355 is capable of receiving electric waves from a plurality of GPS satellites in Earth's orbit, and calculating a position of the mobile terminal 300 using a time of arrival from the GPS satellites to the mobile terminal 300. The mobile terminal 300 may include both a WiFi Positioning System (WPS) module and the GPS module 355, or any one of the GPS module and the WPS module.

The input/output module 360 may include at least one of plural buttons 361, a microphone 362, a speaker 363, a vibration motor 364, a connector 365, a keypad 366, and an earphone connecting jack 367. The input/output module 360 except for the connector 365 is used as a means for receiving an input of a user and providing the user with information, and may include a cursor controlling means, e.g., a mouse, a trackball, a joystick, and a directional key, to control movement of a cursor on the touch screen 390 and information communication with the controller 310.

The buttons 361 may be arranged on a front surface, a side surface and a rear surface of the mobile terminal 300, and include at least one of an electric button, a volume control button including a volume increasing button and a volume decreasing button, a menu button, a home button, a back button and a search button.

The microphone 362 receives an input of voice or sound from a user or peripheral environment to generate electric signals under a control of the controller 310.

The speaker 363 is capable of outputting sounds, which correspond to various signals, i.e. radio signals, broadcasting signals, digital audio files, digital video files, and photographing, of the mobile communication module 320, the sub-communication module 330, the multimedia module 340 or the camera module 350, to the exterior of the mobile terminal 300, under a control of the controller 310. The speaker 363 is capable of outputting sounds, i.e. a button operation sound or a ringtone corresponding to a voice call, corresponding to functions which the mobile terminal 300 performs. One or more speakers 363 are arranged on a suitable position or positions of the mobile terminal 300.

The vibration motor 364 is converts electric signals into mechanical vibrations under a control of the controller 310. For example, the mobile terminal 300 staying in a vibration mode operates a vibration motor when a voice call or a video call is received from another device. One or more vibration motors may be arranged within the mobile terminal 300. The vibration motor 364 operates in response to a touch operation of a user who touches the touch screen 390, and a continuous movement of a touch on the touch screen 390.

The connector 365 may be used as an interface to connect the mobile terminal 300 to the external device or an electric power source. The mobile terminal 300 transmits data stored in the storage unit 375 of the mobile terminal 300, to the external device through a wired cable connected to the connector 365, or receives data from the external device, under a control of the controller 310. Further, the mobile terminal 300 is supplied with electric power from the electric power source through the wired cable connected to the connector 365, or is capable of charging a battery using the electric power source.

The keypad 366 receives a key input from a user in order to control the mobile terminal 300. The keypad 366 includes a physical keypad arranged on the mobile terminal 300 or a virtual keypad displayed on the touch screen 390 or elsewhere. An earphone is inserted in the earphone connecting jack 367 and connected to the mobile terminal 300.

The sensor module 370 includes at least one sensor for detecting a state, i.e. position, point of compass, movement and the like, of the mobile terminal 300. For example, the sensor module 370 may include a proximity sensor for detecting whether a user comes close to the mobile terminal 300, an illuminance sensor for detecting an amount of light surrounding the mobile terminal 300, a motion and compass sensor for detecting rotation, acceleration, deceleration or vibration of the mobile terminal 300, and an altimeter for detecting altitude by measuring an atmospheric pressure. Further, the motion/compass sensor may include a geo-magnetic sensor for detecting a point of the compass by using a magnetic field of the Earth, a gravity sensor for detecting an action direction of the gravity, a gyro sensor, an impact sensor, a compass sensor, an acceleration sensor and the like. The sensor module 370 detects a state of the mobile terminal 300, and generates and transmits a signal corresponding to the detection to the controller 310.

The storage unit 375 stores signals or data to be input/output in the mobile communication module 320, the sub-communication module 330, the multimedia module 340, the camera module 350, the GPS module 355, the input/output module 360, the sensor module 370, or the touch screen 390, under a control of the controller 310. The storage unit 375 may store a control program and applications for controlling the mobile terminal 300 or the controller 310. The term “storage unit” refers to the storage unit 375, the ROM 312, the RAM 313, or a memory card, e.g., a SD card and a memory stick, inserted in the mobile terminal 300.

The storage unit 375 may store applications such as a navigation application, a video call application, a game application, an alarm application based on time, which have different functions, images for providing a Graphical User Interface (GUI) relating to the applications, databases or data relating to a method of processing user information, a document and a touch input, background images or operation programs, i.e. a menu screen, a standby screen, and the like, necessary for an operation of the mobile terminal 300, images taken by the camera module 350, and the like. The storage unit 375 is a non-transitory medium which is read by a machine, e.g., a computer. The term “medium read by the machine” may be defined as a medium capable of providing data to the machine so that the machine performs a specific function. The storage unit 375 may include a non-volatile medium and a volatile medium, including one or more of a floppy disk, a flexible disk, a hard disk, a magnetic tape, a Compact Disc Read-Only Memory (CD-ROM), an optical disk, a punch card, a paper tape, a RAM, a Programmable Read-Only Memory (PROM), an Erasable PROM (EPROM), and a Flash EPROM.

The electric power supply unit 380 includes one or more batteries disposed in the mobile terminal 300, to supply electric power under a control of the controller 310 to the mobile terminal 300. Further, the electric power supply unit 380 is capable of supplying electric power to the mobile terminal 300 from the external electric power source through the wired cable connected to the connector 365. Further, the power supply unit 380 may supply the mobile terminal 300 with electric power wirelessly input from the external electric power source by using a wireless charging technique.

The touch screen 390 displays data input from the controller 310 for a user and provides the user with the GUI corresponding to various services, i.e. a voice call, a data transmission, broadcasting, and photographing The touch screen 390 transmits analog signals, which correspond to at least one touch input or a hovering input for the GUI, to the touch screen controller 395. The touch screen 390 is capable of receiving at least one input through an input means of a user, i.e. finger, pen, and the like. Further, the touch screen 390 may receive continuous movement, i.e. drag, of a touch. The touch screen 390 may transmit analog signals, which correspond to the continuous movement of the input touch, to the touch screen controller 395.

Further, the mobile terminal 300 can include a pen or stylus insertable into the mobile terminal 300 for storage therein and can be drawn from the mobile terminal 300 for use. Furthermore, in the present invention, a touch screen input is not limited to a contact of the input means, e.g. a finger, pen or stylus. The user may interact with the touch screen 390 by non-contact detection which detects input when the input means is closer that a preset distance, e.g., 1 cm, from the touch screen 390. A distance at which the touch screen 390 recognizes an input is able to be varied according to a performance or a structure of the mobile terminal 300, and especially, the touch screen 390 and/or the pen have variable output values according to a gap (or a contact and a non-contact) between the touch screen 390 and the input means of the user in order to distinguish a touch event caused by a contact with the input means of the user and an input event, i.e. hovering, in a non-contact state. That is, the touch screen 390 differently outputs a value detected through the touch event, i.e. for example, a current value, a voltage value, a resistance value, an electrostatic capacitance, and a value detected through a hovering event.

On the other hand, the touch screen controller 395 converts analog signals received from the touch screen 390 into digital signals, for example, X and Y coordinates and input an intensity value (or a detected value), and transmits the digital signals to the controller 310. The controller 310 controls the touch screen 390 by using the digital signals received from the touch screen controller 395. For example, the controller 310 controls a shortcut icon or corresponding application displayed on the touch screen 390 to be selected or executed in response to a touch event or a hovering event. The touch screen controller 395 may calculate a distance between the user input means and the touch screen 390 based on a value output from the touch screen 390, and may convert a calculated distance value into a digital signal, i.e. Z coordinate, so as to provide the digital signal to the controller 310. The touch screen 390 may include at least two touch screen panels capable of detecting a finger input and a pen input in order to distinguish an input, i.e. a finger input, by a first user input means which includes a first user input means, i.e. a part of body such as a finger, and is a passive type, and an input, i.e. a pen input, by a pen which is an active type of a second user input means. With the user input means, a classification of a passive type and an active type can be achieved by generating or inducing energy such as electronic waves and electromagnetic waves. The at least two touch screen panels provide different output values to the touch screen controller 395, and the touch screen controller 395 may differently recognize values input from the at least two touch screen panels so as to distinguish whether the input of the respective touch screens 390 is generated by a finger or a pen. For example, the touch screen 390 may be a combination of a capacitive typed touch screen panel and an electromagnetic resonance typed touch screen panel. Further, as described above, since the touch screen 390 includes touch keys such as a menu button, a back button and the like, a finger input mentioned in the present invention or a finger input on the touch screen 390 includes a touch input through the touch keys. The respective structural elements of the mobile terminal 300 shown in FIG. 3 are mounted on a main board. For example, smart phones are currently and typically used as the mobile terminals, a size of the touch screen 390 increases similarly to that of the terminal and the touch screen 390 is disposed on the main board. Hereinafter, a coupler structure in which data is transmitted at a high speed between the structural element such as touch screen, and the main board, or between boards capable of transmitting and receiving data in the mobile terminal will be described.

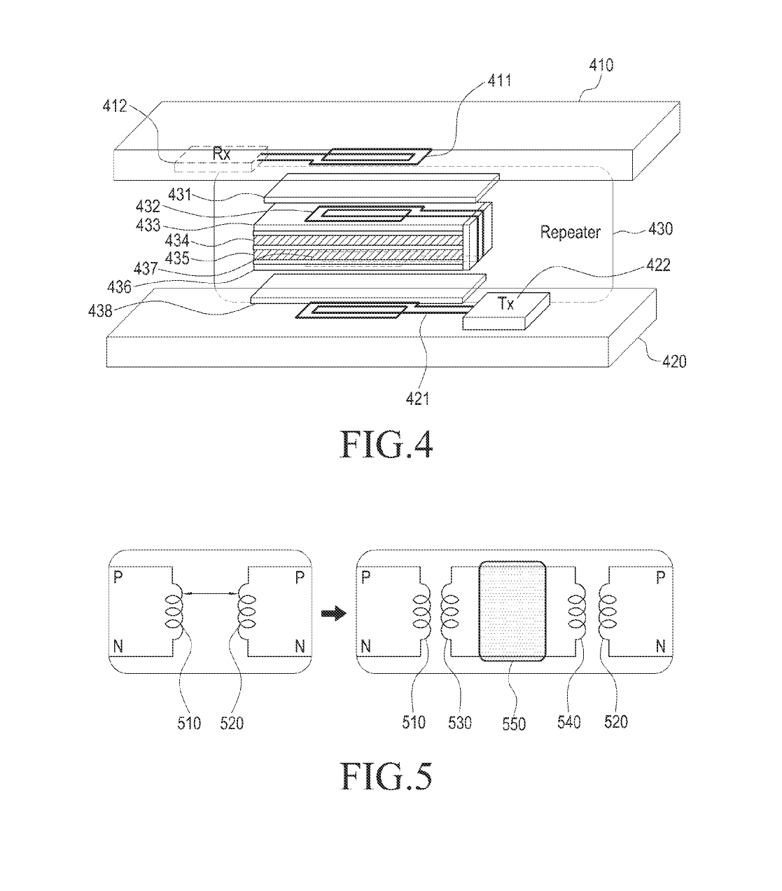

FIG. 4 illustrates a structure of a coupler for transmitting data between structural elements in a mobile terminal at a high speed according to an embodiment of the present invention.

The coupler shown in FIG. 4 transmits data at a high speed between the structural elements in the mobile terminal, with a repeater arranged between the first substrate and the second substrate.

The first substrate 410 includes a coupler 411 and an Integrated Circuit (IC) 412, and the second substrate 420 includes a coupler 421 and an IC 420. The first substrate 410 and the second substrate 420 are spaced at a predetermined distance, and have the repeater 430 intervened there between. In this structure, a coupling is formed between the couplers 411 and 421 of the respective substrates, so that data or electric power can be transmitted and received. For example, provided that the coupler 411 of the first substrate 410 is a receiving coupler while the coupler 421 of the second substrate is a transmitting coupler, signals output from the IC 422 of the second substrate 420 are transmitted to the IC 412 through the coupling between the couplers 411 and 421. Further, the repeater 430 has couplers which are formed at a side thereof opposite to the first substrate and at a side thereof opposite to the second substrate respectively, and spaced at a predetermined distance from the first and second substrates. As shown in FIG. 4, a first repeater coupler 432 is formed on an upper surface of the repeater 430 opposite to the first substrate 410, and a second repeater coupler 437 is formed on a lower surface of the repeater 430 opposite to the second substrate 420. The respective couplers 432 and 437 formed on the repeater have a larger inductance value than that of the couplers 411 and 421 formed on the first and second substrates.

Adhesive films are provided between the upper surface of the repeater 430 and the lower surface of the first substrate 410, and between the lower surface of the repeater 430 and the upper surface of the second substrate 420, respectively. As described above, the repeater 430 has the adhesive films attached to the upper surface and the lower surface thereof, and includes at least one magnetic shield material and at least one flexible substrate. For example, the repeater has a first flexible substrate 433 formed below the adhesive film formed on the upper surface thereof, and a second flexible substrate 436 formed on the adhesive film 438 formed on the lower surface thereof. The repeater has a first magnetic shield material 434 formed below the first flexible substrate 433, and a second magnetic shield material 435 formed below the second flexible substrate 436.

In addition, the repeater 430 is formed so that the first flexible substrate 433 and the first shield material 434, the first shield material 434 and the second magnetic shield material 435, the second magnetic shield material 435 and the second flexible substrate 436 are spaced a predetermined distance apart from one another, with the predetermined distance varying by design.

FIG. 5 illustrates an equivalent circuit of FIG. 4 according to an embodiment of the present invention.

As shown on the left side of FIG. 5, a reactance 510 of the first substrate 410 is spaced at a predetermined distance, i.e. 1 mm, from a reactance 520 of the second substrate 420 so as to form a coupling. When the repeater 430 is added in this structure, as shown on the right side of FIG. 5, a coupling is formed between the reactance 520 of the second substrate 420 and a reactance 530 of the second repeater coupler 437 formed on the lower surface of the repeater 430. Likewise, a coupling is also formed between the reactance 510 of the first substrate 410 and the reactance 540 of the first repeater coupler 432 formed on the upper surface of the repeater 430. The two reactance gaps of the coupling are spaced at a predetermined distance, i.e. 0.1 mm, from each other. Preferably, a distance of the two reactance gaps may be smaller than 0.1 mm. As a result, a maximum thickness of the repeater is thinner than 1 mm. In the example, it will be known that the thickness of the repeater is 0.8 mm. The repeater 430 has a magnetic shield material 550 arranged at a center portion thereof.

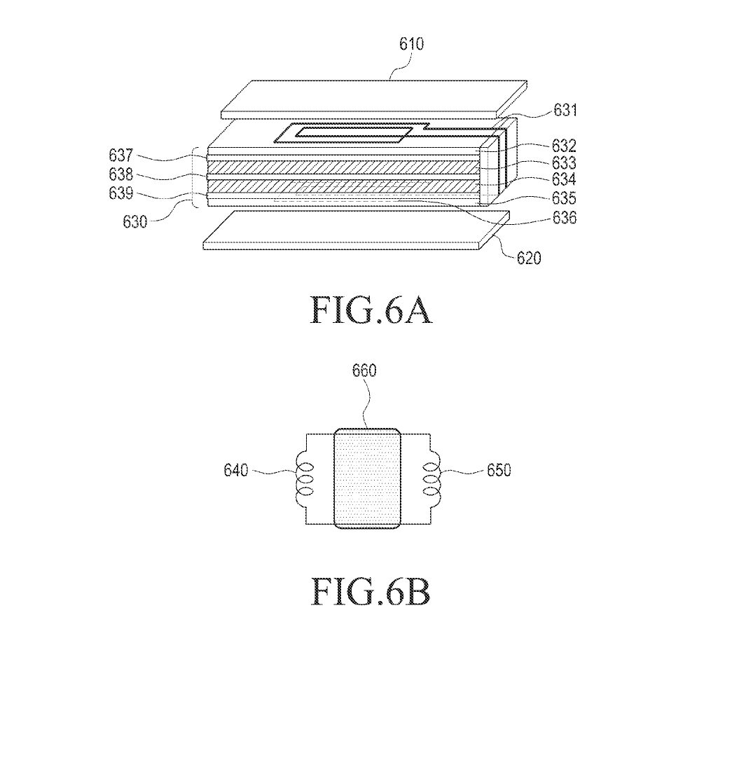

FIG. 6A illustrates a repeater according to an embodiment of the present invention, with the repeater made of a magnetic shield material. FIG. 6B illustrates an equivalent circuit of FIG. 6A.

As shown in FIGS. 6A and 6B, the repeater has adhesive films 610 and 620 arranged at positions spaced at a predetermined distance from the upper and lower surfaces of the repeater 630. The repeater has couplers 631 and 636 formed on the upper surface and the lower surface thereof, respectively. The couplers 631 and 636 are connected to each other so as to form a coupling. Since the coupling formed between the couplers 631 and 636 causes interference, the magnetic shield materials 633 and 634, and the flexible substrates 632 and 635 are arranged between couplers 631 and 636.

Particularly, the repeater 630 is formed by disposing the second flexible substrate 635, spaced at a predetermined distance from the second adhesive film 634. A first spacer 639 is placed above the second flexible substrate 635, which is separated by a predetermined distance from the second magnetic shield material 634. The first magnetic shield material 633 uses a second spacer 638 to form a space and separation from the first flexible substrate 632, which is spaced at a predetermined distance from the first magnetic shield material 633 by a third spacer 637. The respective layers are separated from one another at a predetermined distance, or another material is added to the space to shield a coupling created on upper and lower surfaces of the repeater 630.

Referring to FIG. 6B, the upper surface coupler 631 is formed on the first flexible substrate 632 arranged on the upper surface of the repeater 630, and the coupling may be formed between reactance 640 of the upper surface coupler 631 and reactance 650 of the lower surface coupler 636 formed on the second flexible substrate 635. A magnetic shield material 660 is formed in order to shield the coupling.

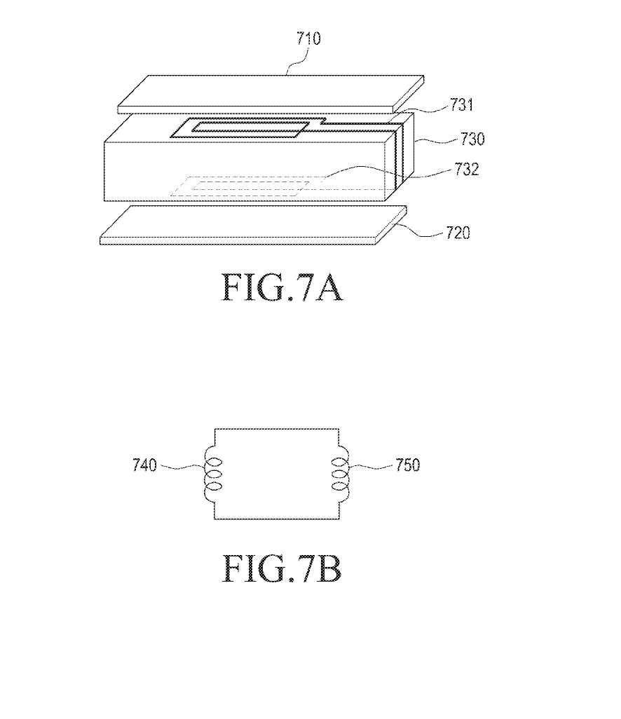

FIG. 7A illustrates a structure of the repeater which is not made of a magnetic shield material, and FIG. 7B illustrates an equivalent circuit of FIG. 7A.

As shown in FIGS. 7A and 7B, the repeater has adhesive films 710 and 720 arranged at positions spaced at a predetermined distance from the upper and lower surfaces of the repeater 730. The repeater has couplers 731 and 732 formed on the upper surface and the lower surface thereof, respectively. The repeater 730 may be a structural element included in the mobile terminal or a substrate, and the couplers 731 and 732 formed on the upper and lower surfaces of the repeater may be connected.

Referring to FIG. 7B, the coupler 731 arranged on the upper surface of the repeater 730 is expressed as a first reactance 740, and the coupler 732 arranged on the lower surface of the repeater 730 is expressed as a second reactance 750. The repeater having the above mentioned structure lacks magnetic shield material at an intermediate portion thereof, differently from that shown in FIG. 6A, and may be a Printed Circuit Board (PCB). The repeater shown in FIG. 7B has a simple structure than the repeater of FIG. 7A.

Moreover, the coupler according to the present invention may have an identical structure for each coupler between a transmission coupler and a reception coupler, and may have a large amount of inductance. The couplers spaced at a predetermined distance are connected to one another by a line pattern, a flexible substrate, via or rigid substrate. The transmission coupler is spaced apart from the reception coupler at a distance within 100 μm, and is designed to have large mutual inductance. That is, the transmission coupler and the reception coupler are designed to have large inductance with the inductance maintaining the magnetic resonance frequency value within a predetermined magnitude. In addition, the repeater according to an embodiment of the present invention may be designed to have a different thickness depending on a spaced distance.

Hereinafter, a structural property of the repeater according to the present invention will be described in detail.

An embodiment of the present invention adds a repeater to a conventional coupler structure, with the repeater increasing the mutual inductance between substrates. The repeater may made of a magnetic shield material, as shown in FIG. 6A, or the repeater may lack the magnetic shield material, as shown in FIG. 7A.

The coupler structure in which the repeater is included increases the mutual inductance and the magnetic resonance frequency to allow data and electric power transmission with a small loss. The mutual inductance may be calculated by Equation (1):

M=k·\sqrt{L_{Tx}·L_{Rx}} (1)

In Equation (1), M is mutual inductance, LTx denotes inductance of a transmission coupler, and LRx denotes inductance of a reception coupler. k is a coupling constant, and can be obtained by a magnitude of a coupler and a distance between the transmission coupler and the reception coupler. The k is in proportion to the magnitude of the coupler, and in inverse proportion to the distance between the transmission coupler and the reception coupler.

The mutual inductance has a large value to facilitate data transmission and reduced electric power usage. Therefore, the inductance of the transmission coupler and the inductance of the reception coupler have a large value. On the other hand, the Self-Resonance Frequency (SRF), which is increased to transmit data at a high speed, can be calculated by Equation (2):

SRF=1/\sqrt{L·C} (2)

In Equation (2), L is inductance of the coupler, and C is parasitic capacitance of the coupler. Since the SRF has is increased to transmit data at a high speed, the coupler and/or parasitic capacitance must have small inductance.

The present invention makes it possible to transmit data using less electric power by decreasing a distance between the couplers, thereby changing the coupling constant k in Equation (1). Furthermore, when a reactance value and a capacitor value are fixed, and when the distance between couplers is decreased, for example from 1 mm to 0.1 mm, a value of the coupling constant increases and a value of the mutual inductance between the couplers increases. By fixing inductance of the coupler to satisfy a high magnetic resonance frequency, i.e. 1 Ghz to several Ghz, a coupler structure is provided capable of transmitting data having mutual inductance larger than critical value at a high speed. The critical value is an inductance value for minimum electric power to restore signals which are received through the reception coupler.

According to the present invention, the repeater is added to reduce the value of the coupling constant k of a distance between the repeater and each substrate, thereby increasing the value of the coupling constant and the mutual inductance between the substrates.

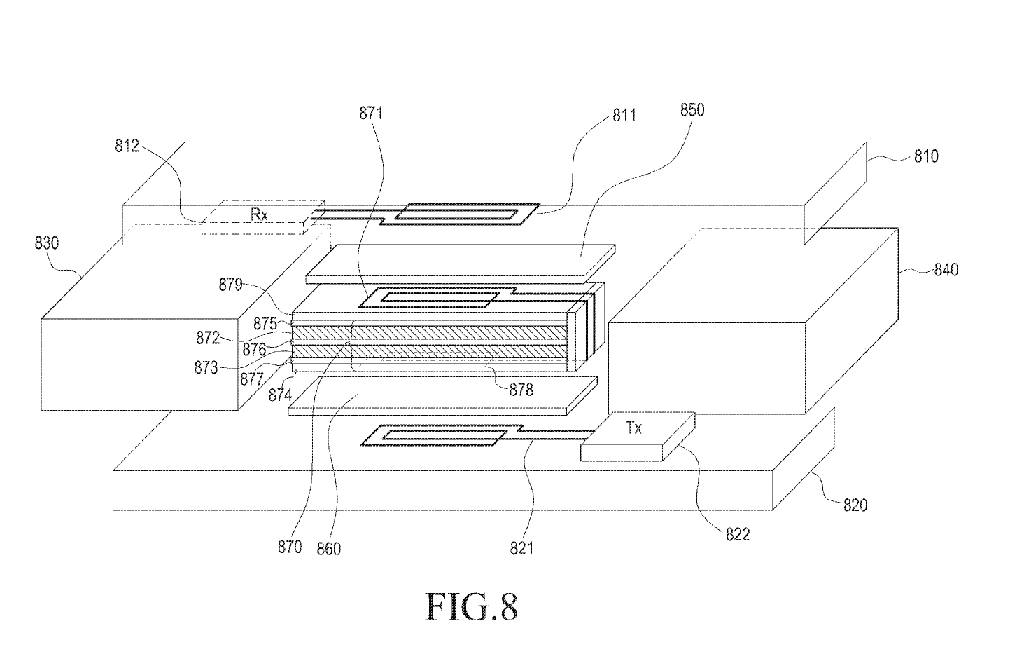

FIG. 8 illustrates a structure of a coupler in which a repeater is applied between structural elements in a mobile terminal according to an embodiment of the present invention.

As shown in FIG. 8, the structure of the coupler includes a first substrate 810, a second substrate 820, and a repeater 870 intervened between the first substrate 810 and the second substrate 820. Moreover, adhesive films 850 and 860 are formed on upper and lower surfaces of the repeater 870, and at least one bracket, formed by arms 830 and 840, disposed between the first substrate 810 and the second substrate 820. The first substrate 810 may be a display unit such as a touch screen, and the second substrate 820 may be a main board of the mobile terminal.

More particularly, the first substrate 810 includes a coupler 811 and an IC 812, and the second substrate 820 includes a coupler 821 and an IC 822. The first substrate 810 and the second substrate 820 are spaced at a predetermined distance, and have the repeater 870 intervened there between. In the coupler structure, it is assumed that the first substrate may be the display unit such as the touch screen, and the second substrate 820 may be the main board of the mobile terminal. Further, provided that the coupler 811 of the first substrate 810 is a receiving coupler while the coupler 821 of the second substrate 820 is a transmission coupler, signals output from the IC 822 of the second substrate 820 are transmitted to the IC 811 through the coupling between the couplers 812 and 821. Voice and video data received by the IC 811 of the first substrate 810 are displayed on the display unit such as the touch screen. Further, the repeater 870 has couplers which are formed at a side thereof opposite to the first substrate 810 and at a side thereof opposite to the second substrate 820, respectively, and spaced at a predetermined distance from the first substrate 810 and the second substrate 820, respectively. As shown in FIG. 8, a first repeater coupler 871 is formed on an upper surface of the repeater 870 opposite to the first substrate 810, and a second repeater coupler 878 is formed on a lower surface of the repeater 870 opposite to the second substrate 820. The respective couplers 871 and 878 formed on the repeater have a larger inductance value than that of the couplers 811 and 821 formed on the first and second substrates.

Adhesive films are intervened between the upper surface of the repeater 870 and the lower surface of the first substrate 810, and between the lower surface of the repeater 870 and the upper surface of the second substrate 820, respectively. As described above in regards to FIG. 6, the repeater 870 has the adhesive films attached to the upper surface and the lower surface thereof, and includes at least one magnetic shield material and at least one flexible substrate. For example, the first repeater coupler 871 has a first flexible substrate 879 formed below the adhesive film 850 which is attached on the upper surface thereof, and a second flexible substrate 874 formed on the adhesive film 860 which is attached on the lower surface thereof. The repeater has a first magnetic shield material 872 formed by intervening a first spacer 875 beneath the first flexible substrate 879, and a second magnetic shield material 873 formed by intervening a second spacer 877 beneath a second flexible substrate 874. A third spacer 876 is intervened between the first magnetic shield material 872 and the second magnetic shield material 873.

In addition, the repeater 870 is formed so that the first flexible substrate 879, the first magnetic shield material 872, the second magnetic shield material 873, and the second flexible substrate 874 are spaced at a predetermined distance from one another.

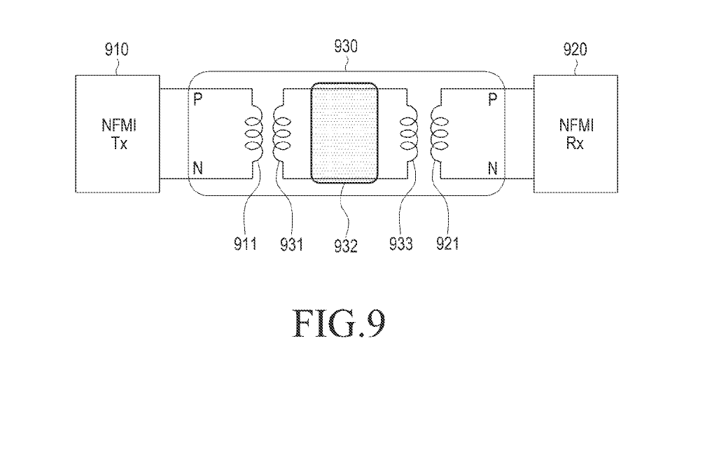

FIG. 9 illustrates an equivalent circuit of FIG. 8 according to an embodiment of the present invention.

As shown in FIG. 9, the repeater 930 has a transmission NFMITx 910 and a reception NFMIRx 920. Reactance 921 of the first substrate 810 is spaced at a predetermined distance, i.e. 1 mm, from reactance 911 of the second substrate 820 to form a coupling. When the repeater 930 is added in this structure, a coupling is formed between the reactance 911 of the second substrate 820 and a reactance 931 of the coupler formed on the lower surface of the repeater 930. Likewise, a coupling is also formed between the reactance 921 of the first substrate 810 and the reactance 933 of the coupler formed on the upper surface of the repeater 930. The two reactance couplings form a single reactance coupling across repeater 930, spaced at a predetermined distance, i.e. 0.1 mm. Preferably, a distance of the two pieces of reactance may be smaller than 0.1 mm. As a result, a maximum thickness of the repeater is less than 1 mm, with a repeater thickness of 0.8 mm. The repeater includes a magnetic shield material 932 arranged at a center portion thereof.

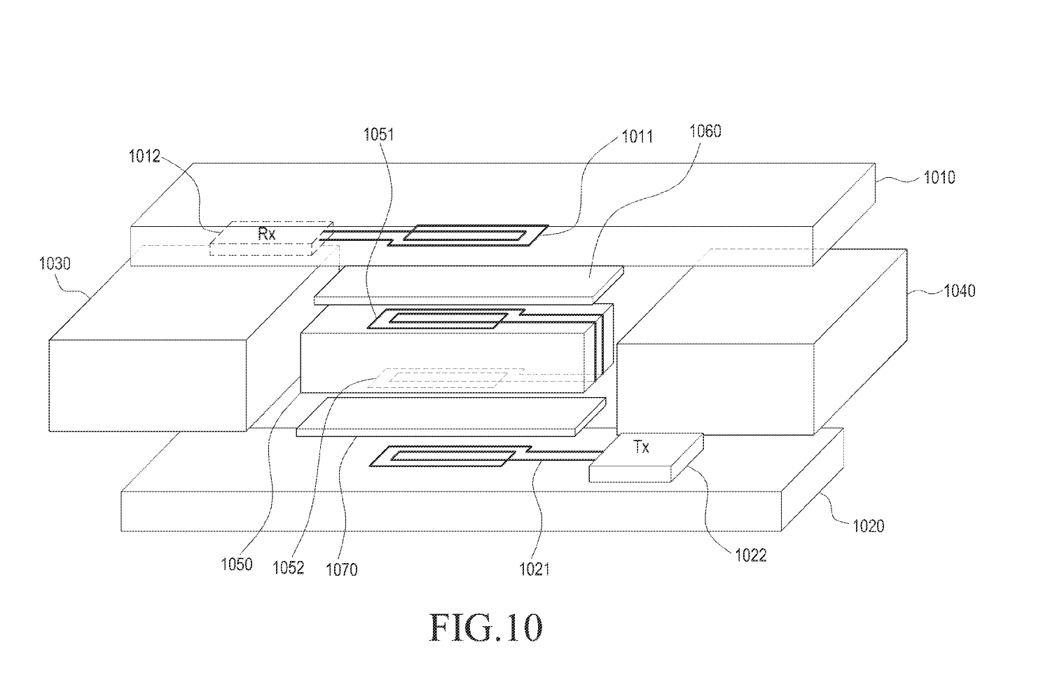

FIG. 10 illustrates a structure of a coupler in which a repeater is applied between structural elements in a mobile terminal according to an embodiment of the present invention.

As shown in FIG. 10, a repeater is provided between structural elements in the mobile terminal, with the repeater having adhesive films 1060 and 1070 arranged at positions spaced at a predetermined distance from the upper and lower surfaces of the repeater 1050. The repeater has couplers 1051 and 1052 formed on respective upper and lower surfaces thereof. The repeater 1050 may be a structural element or a substrate included in the mobile terminal, and the couplers 1051 and 1052 formed on the upper and lower surfaces of the repeater may share an electrical connection. Furthermore, at least one bracket having arms 1030 and 1040 intervenes between the first substrate 1010 and the second substrate 1020. The first substrate 1010 includes a coupler 1011 and a reception IC 1012 for receiving data or electric power from a transmission IC 1022 of the second substrate 1020, and the second substrate 1020 includes coupler 1021 for transmitting data or electric power to the reception coupler 1011 of the first substrate 1010. The first substrate may be a display unit such as a touch screen, and the second substrate may be a main board of the mobile terminal.

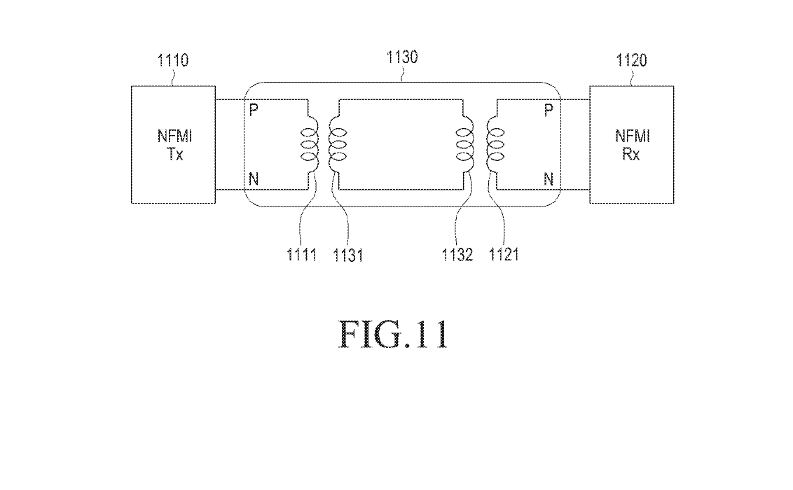

FIG. 11 illustrates an equivalent circuit of a coupler structure of FIG. 10 according to an embodiment of the present invention.

As shown in FIG. 11, the repeater 1130 has a transmission NFMITx 1110 and a reception NFMIRx 1120, and the couplers of the present invention are arranged on the upper and lower surfaces of the repeater 1130, respectively. For example, the coupler 1051 arranged on the upper surface of the repeater 1050 is expressed as a first reactance 1132, and the coupler 1052 arranged on the lower surface of the repeater 1050 is expressed as a second reactance 1131. The repeater having the above mentioned structure has no magnetic shield material at an intermediate portion thereof, which is different from the repeater FIG. 8, and may be a Printed Circuit Board (PCB).

As shown in FIG. 11, a reactance 1121 of the first substrate 1010 is spaced at a predetermined distance, i.e. 1 mm, from a reactance 1111 of the second substrate 1020 so as to form a coupling. When the repeater 1050 is added in this structure, a coupling is formed between the reactance 1111 of the second substrate 1020 and a reactance 1131 of the coupler formed on the lower surface of the repeater 1050. Likewise, a coupling is also formed between the reactance 1121 of the first substrate 1010 and the reactance 1132 of the coupler formed on the upper surface of the repeater 1132. The first and second reactances 1132 and 1131 forming the coupling are spaced at a predetermined distance, i.e. 0.1 mm from each other. Preferably, a distance between the first and second reactances may be smaller than 0.1 mm. As a result, a maximum thickness of the repeater is thinner than 1 mm, with a thickness of the repeater of 0.8 mm. The repeater has a magnetic shield material arranged at a center portion thereof. Hereinafter, an examination result of a coupler structure to which a repeater according to the present invention is applied, and a conventional coupler structure to which a repeater is applied will be described.

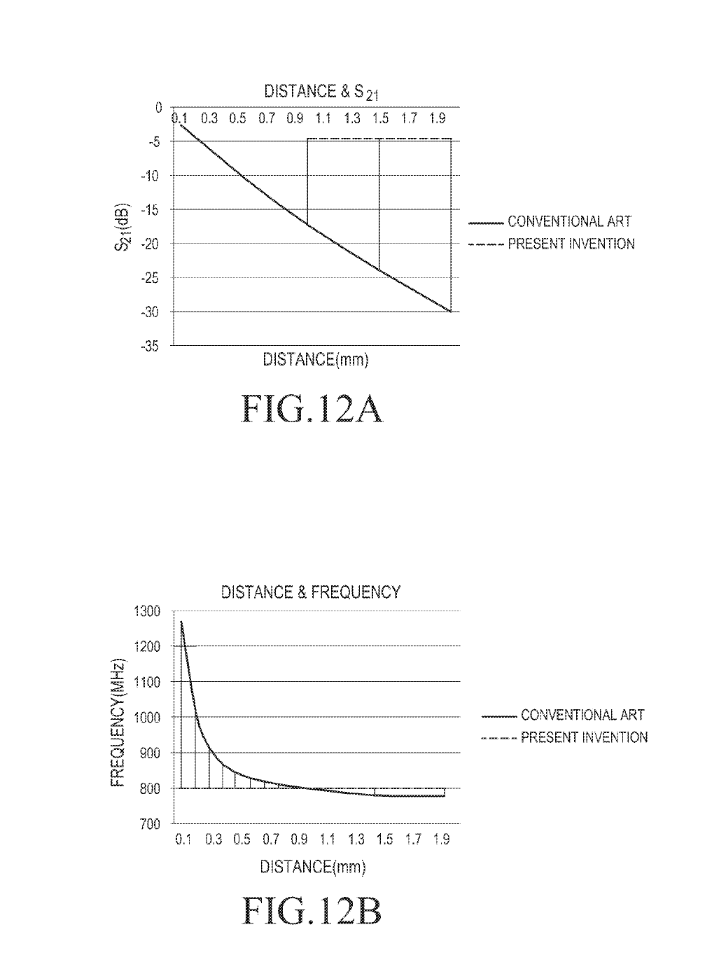

FIGS. 12A and 12B show a variation of a magnitude of mutual inductance, i.e. a differential S₂₁ property, depending on a variation of a distance between the transmission coupler and the reception coupler, and a variation of a frequency, i.e. a S₂₁ peak frequency, for transmitting data, according to the present invention. FIG. 12A is a graph illustrating a result of comparing the differential S₂₁ property, depending on the variation of the distance between the couplers, and FIG. 12B is a graph illustrating a result of comparing the variation of the frequency according to the present invention with the variation of the frequency according to the conventional art depending on the distance between the couplers.

First, an examination is performed under a condition that the coupler has a size of 2.5 mm×2.5 mm and a reference distance between the couplers is 1 mm. An examination tool uses a High Frequency Structure Simulator (HFSS). The examination is carried out under a condition with a repeater is applied to the coupler and with the repeater not being applied to the coupler.

As shown in FIG. 12A, in the conventional art, when the distance between the couplers increases, a value of S₂₁ is reduced. However, in the present invention, even though the distance between the couplers increases, the S₂₁ value does not vary. That is, even though the distance between the couplers increases from about 1.0 mm to about 2.0 mm, a property of the S₂₁ value does not vary and stability is maintained within −5 dB in a range of the distance of more than 1 mm between the couplers.

As shown in FIG. 12B, in the conventional art, as the distance between the couplers increases, the severe variation of the frequency occurs because the frequency is rapidly lowered, i.e. from 1270 Mhz to 780 Mhz. However, according to the present invention, since the frequency is stable, i.e., the frequency is evenly maintained at 800 Mhz, without the variation even though the distance increases, a system design and a data transmission can be stably established.

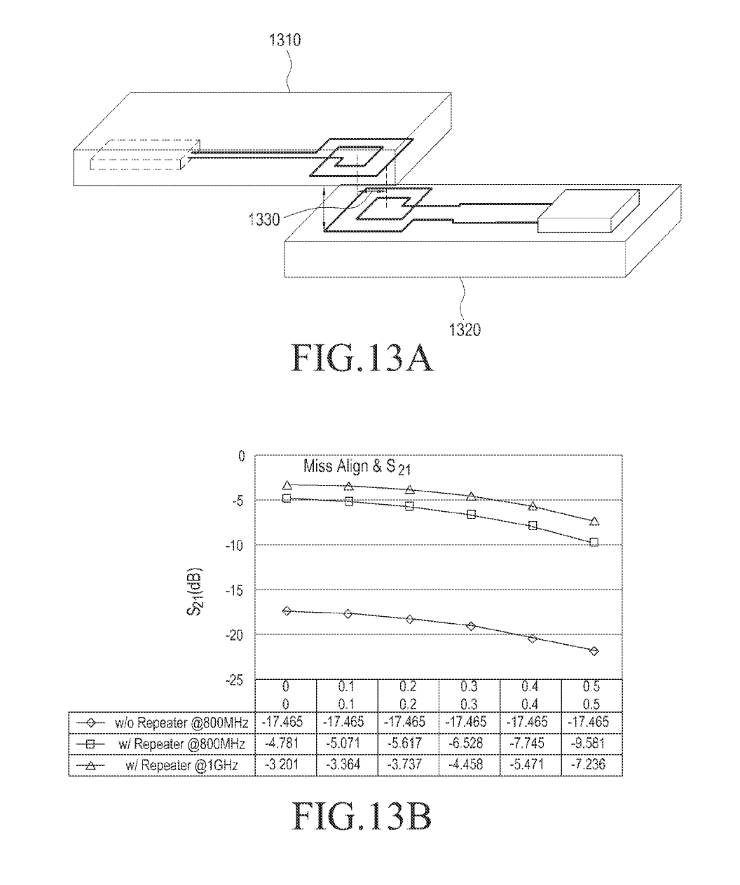

FIGS. 13A and 13B illustrate a result of comparing an effect according to the conventional art with an effect due to a misaligned arrangement of the transmission coupler and the reception coupler in proportion to the distance between the couplers when a repeater according to the present invention is applied to the couplers. FIG. 13A illustrates an example of the misaligned arrangement of the transmission coupler and the reception coupler according to the distance between the couplers. FIG. 13B illustrates a result from the misaligned arrangement of the transmission coupler and the reception coupler according to the distance between the couplers.

As shown in FIG. 13A, the first substrate 1320 including the transmission coupler, and the second substrate 1310 including the reception coupler are misaligned, as depicted by 1330, around a center portion of each coupler.

As shown in FIG. 13B, when the couplers are misaligned in the arrangement, even though the distance between the couplers increases, the coupler structures of the present invention and the conventional art have no large difference in a variation of a property reduction. In addition, the present invention provides better properties than the conventional art for differences of an absolute value of the S₂₁.

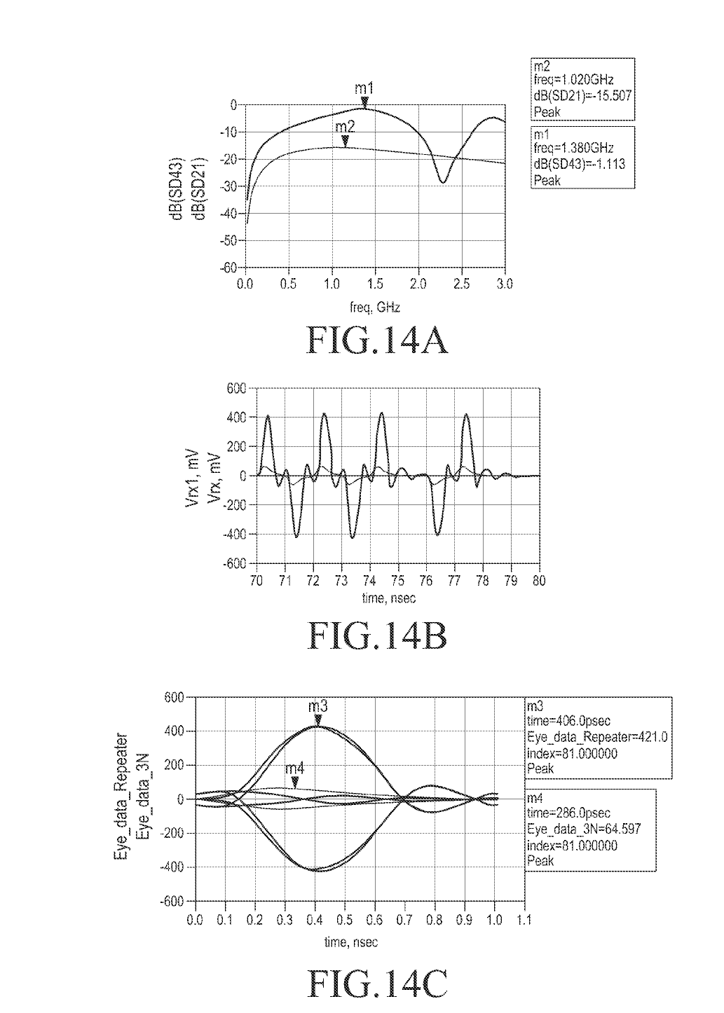

FIGS. 14A to 14C illustrate a result of transmitting a high rate digital data through a coupler in an axis of time which is a result of an examination performed by an Advanced Design System (ADS) after an examination result by a High Frequency Structure Simulator (HFSS) is extracted into a 4-port S-Parameter (S4P) file, when a repeater according to the present invention is applied to the coupler.

As shown in FIGS. 14A to 14C, the amplitude of a voltage increases six times that of the conventional coupler when the repeater according to the present invention is applied to the coupler, and the coupler has an improved performance over the conventional coupler when data is transmitted at a high speed along a time axis.

It may be appreciated that the embodiments of the present invention can be implemented in software, hardware, or a combination thereof. Any such software may be stored, for example, in a volatile or non-volatile storage device such as a ROM, a memory such as a RAM, a memory chip, a memory device, or a memory IC, or a recordable optical or magnetic medium such as a CD, a DVD, a magnetic disk, or a magnetic tape, regardless of its ability to be erased or its ability to be re-recorded. It can be seen that a memory which may be included in the mobile terminal corresponds to an example of the storage medium suitable for storing a program or programs including instructions by which the embodiments of the present invention are realized. Therefore, embodiments of the present invention provide a program including codes for implementing a system or method, and a machine-readable device for storing such a program. Moreover, such a program can be electronically transferred through an arbitrary medium such as a communication signal transferred through cable or wireless connection, and equivalents thereof. Moreover, the above-described mobile terminal can receive the program from a program provision device which is connected thereto in a wired or wireless manner, and store the program.

The program providing apparatus may include a memory for storing a program containing instructions for allowing the camera apparatus to perform a preset content protecting method and information required for the content protecting method, a communication unit for performing wired or wireless communication with the camera apparatus, and a controller for transmitting the corresponding program to the camera apparatus according to a request of the camera apparatus or automatically.

Meanwhile, although specific embodiments have been described in the detailed descriptions of the present invention, it is apparent that various modifications may be implemented without departing from the scope of the present invention. Therefore, the scope of the present invention should not be defined as being limited to the embodiments, but should be defined by the appended claims and equivalents thereof.

What is claimed is:

1. A coupler structure of a mobile terminal, the coupler structure comprising:
a first substrate having a reception coupler formed thereon;
a second substrate having a transmission coupler formed thereon; and
a repeater disposed between the first substrate and the second substrate.

2. The coupler structure of the mobile terminal as claimed in claim 1, wherein the repeater has a first repeater coupler formed at a side of the repeater opposite to the first substrate and a second repeater coupler formed at a side of the repeater opposite to the second substrate.

3. The coupler structure of the mobile terminal as claimed in claim 1, wherein the repeater is spaced at a predetermined distance from the first and second substrates.

4. The coupler structure of the mobile terminal as claimed in claim 2, wherein an inductance of the first repeater coupler is larger than an inductance of the reception coupler and an inductance of the second repeater coupler is larger than an inductance of the transmission coupler.

5. The coupler structure of the mobile terminal as claimed in claim 1, wherein mutual inductance between the transmission coupler and the reception coupler has a value larger than a critical value as a coupling constant increases.

6. The coupler structure of the mobile terminal as claimed in claim 5, wherein the coupling constant increases as a size of the transmission coupler and the reception coupler increases.

7. The coupler structure of the mobile terminal as claimed in claim 5, wherein the coupling constant increases as distance between the first substrate and the second substrate decreases.

8. The coupler structure of the mobile terminal as claimed in claim 5, wherein the critical value is a minimum electric power to restore a signal received through the reception coupler.

9. The coupler structure of the mobile terminal as claimed in claim 1, wherein the transmission coupler and the reception coupler form a structure in which Self-Resonance Frequency (SRF) increases as inductance decreases.

10. The coupler structure of the mobile terminal as claimed in claim 1, wherein a thickness of the repeater varies depending on a distance between the transmission coupler and the reception coupler.

11. The coupler structure of the mobile terminal as claimed in claim 1, wherein the repeater transmits at least one of data signals and electric power, which are received from the transmission coupler, to the reception coupler.

12. The coupler structure of the mobile terminal as claimed in claim 5, wherein the mutual inductance (M) is:
M=k·\sqrt{L_{Tx}·L_{Rx}},
wherein LTx is inductance of the transmission coupler, LRx is inductance of the reception coupler, and k is a coupling constant.

13. The coupler structure of the mobile terminal as claimed in claim 9, wherein the Self-Resonance Frequency is:
SRF=1/\sqrt{L·C},
wherein L is inductance of the coupler and C is parasitic capacitance of the coupler.

14. A coupler structure of a mobile terminal, the coupler structure comprising:
a first substrate;
a second substrate; and
a repeater disposed between the first substrate and the second substrate, with a coupler arranged thereon,
wherein the repeater has adhesive films attached to upper and lower surfaces thereof, and includes at least one magnetic shield material and at least one flexible substrate.

15. The coupler structure of the mobile terminal as claimed in claim 14, wherein the repeater has a first repeater coupler formed at a side of the repeater opposite to the first substrate and a second repeater coupler formed at a side of the repeater opposite to the second substrate.

16. The coupler structure of the mobile terminal as claimed in claim 14, further comprising:
a reception coupler provided on the first substrate; and
a transmission coupler provided on the second substrate,
wherein mutual inductance between the reception coupler and the transmission coupler increases above a critical value when a coupling constant increases.

17. The coupler structure of the mobile terminal as claimed in claim 15, wherein each coupler formed on the repeater has an inductance larger than an inductance value of a coupler formed on a corresponding first substrate or second substrate.

18. The coupler structure of the mobile terminal as claimed in claim 14, wherein the at least one flexible substrate includes a plurality of flexible substrates arranged on upper and lower surfaces of the magnetic shield material, respectively.

19. The coupler structure of the mobile terminal as claimed in claim 14, wherein a first flexible substrate is arranged beneath the adhesive film disposed on the upper surface of the repeater, and a second flexible substrate is arranged on the adhesive film disposed on the lower surface of the repeater.

20. The coupler structure of the mobile terminal as claimed in claim 19, wherein a first magnetic shield material is formed beneath the first flexible substrate, and a second magnetic shield material is formed on the second flexible substrate.

21. The coupler structure of the mobile terminal as claimed in claim 20, wherein the first flexible substrate and the first magnetic shield material, the first magnetic shield material and the second magnetic shield material, and the second magnetic shield material and the second flexible substrate are spaced at a predetermined distance from each other.

22. The coupler structure of the mobile terminal as claimed in claim 16, wherein the critical value is a minimum electric power to restore a received signal.

23. A mobile terminal comprising:
a coupler structure that includes a first substrate, a second substrate; and
a repeater disposed between the first substrate and the second substrate,
wherein the repeater includes adhesive films attached to upper and lower surfaces thereof, and includes at least one magnetic shield material and at least one flexible substrate.
